(19) United States
(12) Patent Application Publication
(10) Pub. No.: US 2009/0122546 A1
(43) Pub. Date: May 14, 2009

(54) Movable Lighting System Providing Adjustable Illumination Zone

(75) Inventor: Chia-Yu Liu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Lite-On IT Corporation, Taipei City (TW)

(21) Appl. No.: 12/104,759

(22) Filed: Apr. 17, 2008

(30) Foreign Application Priority Data
Nov. 8, 2007 (CN) PCT/CN2007/003172

(51) Int. Cl. F21V 17/02; F21S 8/00

(52) U.S. Cl. 362/277

(57) ABSTRACT

A movable lighting system includes at least one lighting unit. The lighting unit includes a light source and a reflector. The reflector encloses the light source and includes a main body and an exit facet. The exit facet of the reflector is beveled with respect to the horizon and adjustable to provide a desired illumination zone and a desired illumination-covering area.

### FIELD OF THE INVENTION

The present invention relates to a movable lighting system, and more particularly to a movable lighting system for providing an adjustable illumination zone and an adjustable illumination-covering area.

### BACKGROUND OF THE INVENTION

In the early stage, lighting devices are used for simply providing a bright place. With diversified living attitudes, in addition to the illuminating purpose, proper lighting devices can enhance task performance or aesthetics. For example, surgical operations need high-intensity lighting systems whose illumination zones have uniform lighting. The lighting systems for stages must provide dazzling and brilliant effects. Moreover, indoor lighting systems are key parts of interior design. In other words, the light source's energy should be efficiently collected and projected onto an object with a desired illuminating distribution.

FIG. 1A schematically illustrates a conventional zoom lighting system. The zoom lighting system includes a light source 1, an inner lens 2 and an external lens 3. By moving the inner lens 2 or the external lens 3 to adjust the distance between the light source 1 and the inner lens 2 or the distance between the light source 1 and external lens 3, the light beam emitted by the light source 1 is either converged or diverged. As shown in FIG. 1B, the external lens 3 is fixed, but the inner lens 2 is moved axially far from the light source 1. Consequently, the light beam emitted by the light source 1 is converged but the light intensity is reduced in comparison with the operation mode of FIG. 1A. Whereas, as shown in FIG. 1C, the inner lens 2 is fixed, but the external lens 3 is moved axially far from the light source 1. Consequently, the light beam emitted by the light source 1 is diverged and the light intensity is reduced in comparison with the operation mode of FIG. 1A. The operation principles shown in FIGS. 1A, 1B and 1C have been adopted to develop some lighting systems, which are disclosed in, for example, U.S. Pat. Nos. 4,101,957, 5,584,568, 6,092,914 and 6,986,593.

Although the lighting system described above can control zoom-in or zoom-out of the illumination zone, the light intensity is reduced. As shown in FIG. 1B and FIG. 1C, since a portion of light emitted by the light source 1 escapes to the surroundings of the lens 2 or 3 and fails to pass through the lens 2 or 3, the light intensity within the illumination zone is reduced and the energy wastage of the lighting system is produced.

In addition, U.S. Pat. Nos. 4,855,884 and 5,752,766 disclosed the lighting systems with variable reflector curvatures to diverge and converge the light. Under control of a motor, the reflector surface is widened or narrowed in order to change the focal length of the reflector surface. Under this circumstance, the light beam emitted by the light source is selectively diverged or converged and thus the illumination zone is adjustable. The mechanisms of changing the reflector surface, however, are very complicated. Besides, they use the conventional light sources such as incandescent bulbs and mercury vapor lamps. The conventional light sources are gradually replaced by light emitting diodes (LEDs) in many applications due to the advantages of small size, no heat radiation, low power consumption, long service life, and quick response speed. Since the divergence of the LED light is less than the conventional light source, LED is not appropriate to be the light source for the lighting system described above.

FIG. 2 schematically illustrates another conventional lighting system. The lighting system includes a plurality of light sources 1. Since the divergence angle for each light source 1 is relatively large, the illumination zone of the light beam emitted by each light source is very broad. As shown in FIG. 2, a great proportion of illumination zone for each light field is superimposed with the illumination zones of the adjacent light sources. Under this circumstance, it is difficult to distinguish the individual illumination zones.

Therefore, there is a need of providing a movable lighting system for providing an adjustable illumination zone so as to obviate the drawbacks encountered from the prior art.

### SUMMARY OF THE INVENTION

The present invention provides a movable lighting system for providing an adjustable illumination zone and an adjustable illumination-covering area.

In accordance with an aspect of the present invention, there is provided a movable lighting system. The movable lighting system includes at least one lighting unit. The lighting unit includes a light source and a reflector. The reflector encloses the light source and includes a main body and an exit facet. The exit facet of the reflector is beveled with respect to the horizon and adjustable to provide a desired illumination zone and a desired illumination-covering area.

### BRIEF DESCRIPTION OF THE DRAWINGS

The above contents of the present invention will become more readily apparent to those ordinarily skilled in the art after reviewing the following detailed description and accompanying drawings, in which:

FIG. 1A schematically illustrates a conventional zoom lighting system;

FIG. 1B schematically illustrates the zoom lighting system of FIG. 1A operated in a converged mode;

FIG. 1C schematically illustrates the zoom lighting system of FIG. 1A operated in a diverged mode;

FIG. 2 schematically illustrates another conventional lighting system;

FIG. 3 schematically illustrates a movable lighting system of the present invention;

FIG. 4 schematically illustrates a lighting unit of the movable lighting system according to a first preferred embodiment of the present invention;

FIG. 5 is a schematic cross-sectional view illustrating three examples of reflector of the lighting unit shown in FIG. 4;

FIG. 6 schematically illustrates a relatively broad illumination-covering area resulting from the movable lighting system of the present invention;

FIG. 7 schematically illustrates a relatively small illumination-covering area resulting from the movable lighting system of the present invention, in which only the middle illumination zone is obtained;

FIG. 8 schematically illustrates a relatively small illumination-covering area resulting from the movable lighting system of the present invention, in which only the left illumination zone is obtained;

FIG. 9 schematically illustrates a relatively small illumination-covering area resulting from the movable lighting system of the present invention, in which only the right illumination zone is obtained; and

FIG. 10 is schematically illustrates a lighting unit of the movable lighting system according to a second preferred embodiment of the present invention.

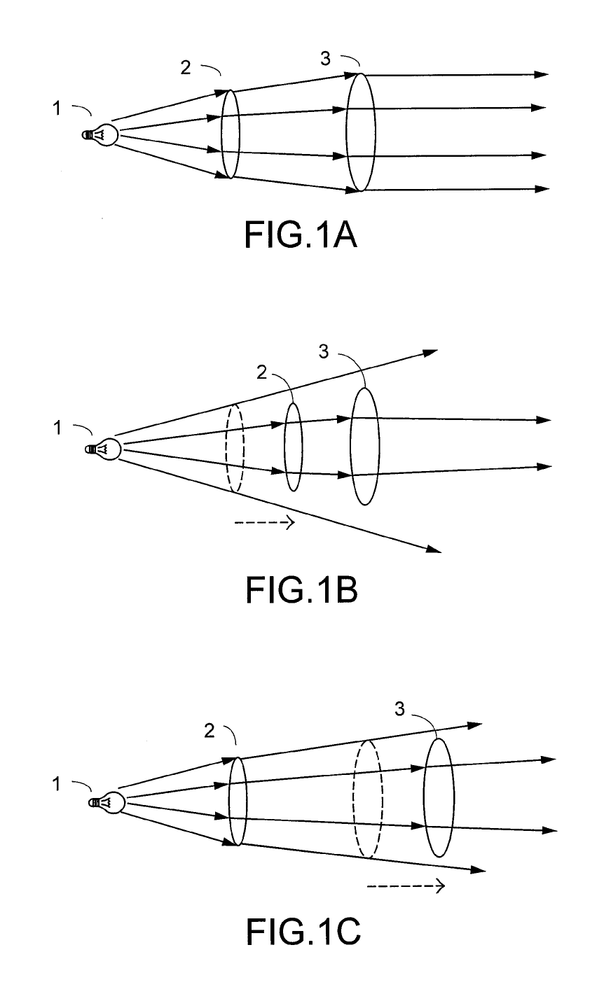

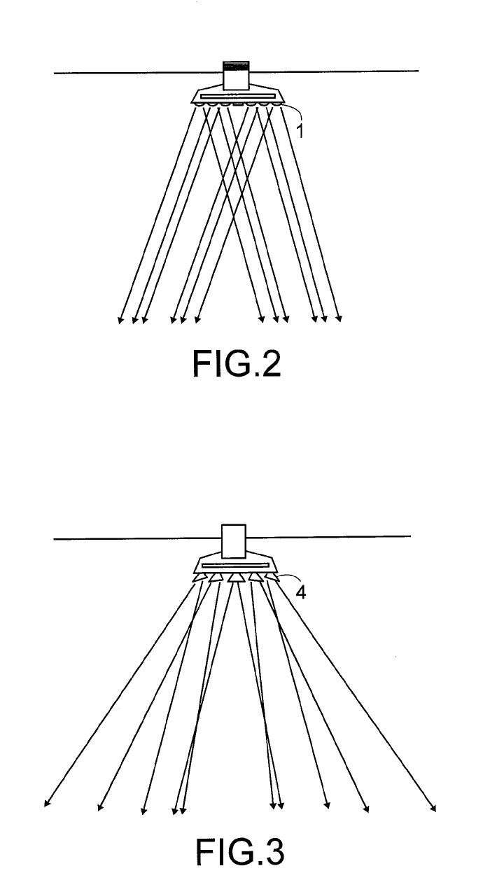

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed. The schematic drawings, not to scale, are employed to illustrate the specific features of the present invention.

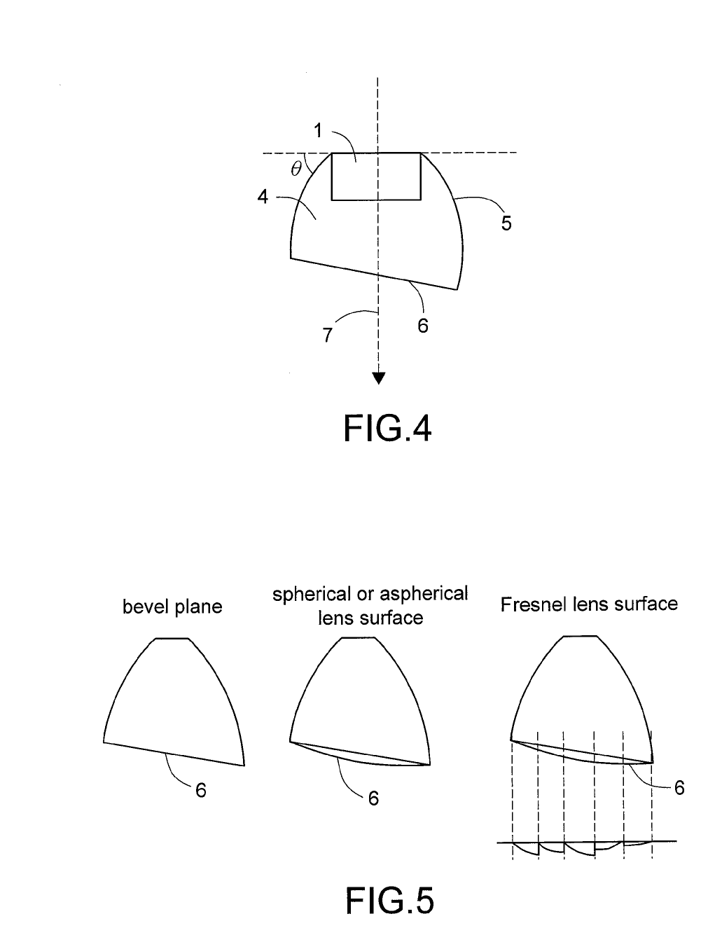

FIG. 3 schematically illustrates a movable lighting system of the present invention. The movable lighting system includes a plurality of lighting units. FIG. 4 schematically illustrates a lighting unit of the movable lighting system according to a first preferred embodiment of the present invention. The lighting unit includes a light source 1 and a reflector 4. The light source 1 is enclosed by the reflector 4. The reflector 4 includes a main body 5 and an exit facet 6. As shown in FIG. 4, an angle θ between the external surface of the main body 5 and the horizon is symmetrically distributed with respect to the optical axis 7. The inner surface of the main body 5 is coated with a reflective film to be as a partially reflective surface or a totally reflective surface. The shape of the main body 5 includes, for example, an ellipsoid, a hyperboloid, a paraboloid, a compound ellipsoid or a compound paraboloid. The scattered light emitted by the light source 1 is reflected and collimated by the reflector body 5 into parallel beams, so that the proportion of the scattered emergent light is reduced and the light intensity within the illumination zone is increased.

Furthermore, as shown in FIG. 4, the exit facet 6 of the lighting unit is beveled with respect to the horizon. In accordance with a key feature of the present invention, the emergence angle of the light for each lighting unit is varied according to the specified configuration of the reflector 4. Please refer to FIG. 5, which is a schematic cross-sectional view illustrating three examples of reflector used in the lighting device of FIG. 4. The exit facet 6 is beveled with respect to the horizon. For example, the exit facet 6 is a bevel plane or includes a bevel lens surface. Depending on the desired angle of the emergent light, the bevel angle of the exit facet 6 with respect to the horizon can be varied. In a case that the light source 1 is a LED array, the bevel angle of the exit facet 6 can be varied according to the locations of respective LEDs. The bevel lens surface of the exit facet 6 can be a spherical lens surface, an aspherical lens surface or a Fresnel lens surface. By adjusting the bevel angle of the exit facet 6 with respect to the horizon, the emergent light is projected on a specified illumination zone in the specified direction. Since the illumination zone of the light beam emitted by each lighting unit is adjustable, the superimposition of the illumination zones is reduced or minimized and the overall illumination-covering area of the lighting system is widened or narrowed as required.

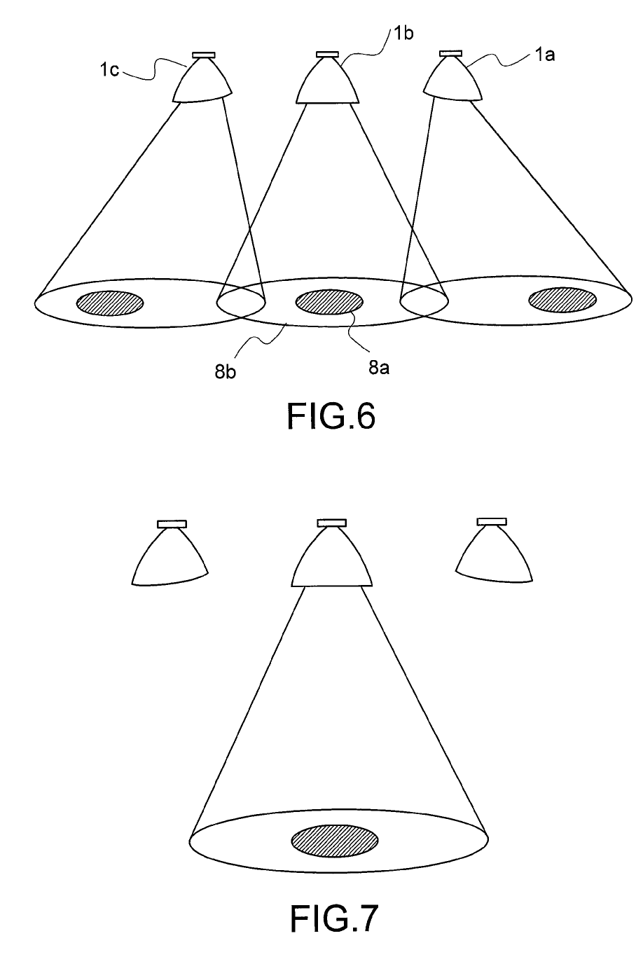

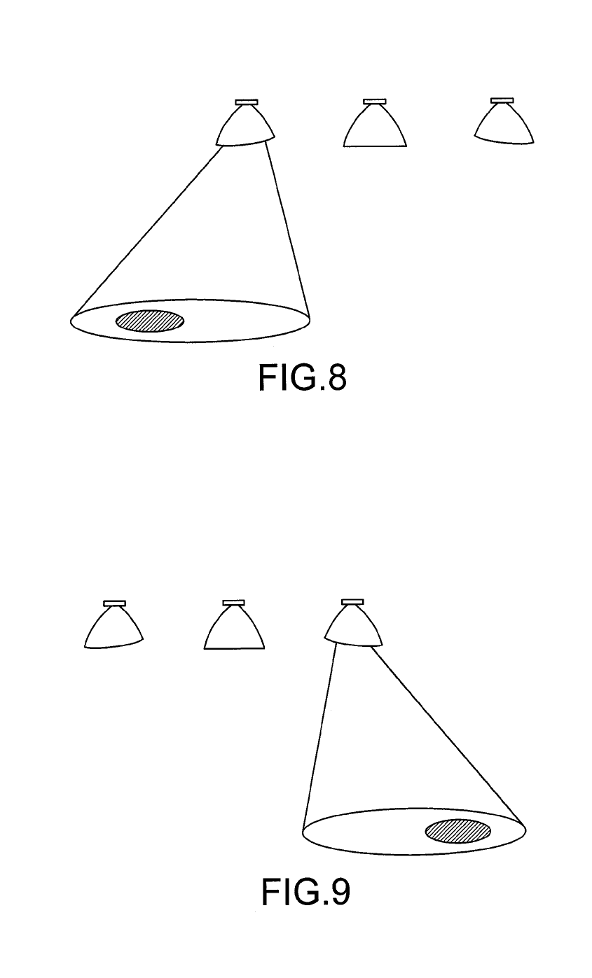

Hereinafter, some implementation examples of the movable light system according to the present invention will be illustrated in more details with reference to FIGS. 6, 7, 8 and 9. The movable light system includes a plurality of lighting units. For clarification, only three lighting units 1a, 1b and 1c are shown in the drawings. The exit facets 6 of these lighting units 1a, 1b and 1c are beveled toward different orientations.

As shown in FIG. 6, the lighting units 1a, 1b and 1c are simultaneously turned on to result in three illumination zones. Take the middle illumination zone 8b for example. The dark region 8a within the illumination zone 8b is a centralized illumination region having relatively larger light intensity. In this embodiment, since these lighting units 1a, 1b and 1c are all turned on, the overall illumination-covering area of the lighting system is very broad. In addition, since the exit facets 6 of these lighting units 1a, 1b and 1c are beveled toward different orientations, the superimposition area between every two illumination zones is minimized. Alternatively, by controlling the bevel angles and bevel orientations of respective exit facets 6, the superimposition areas are changeable such that the overall illumination-covering area of the lighting system is adjustable.

As shown in FIGS. 7, 8 and 9, the middle lighting unit 1b, the left lighting unit 1c, the right lighting unit 1a is respectively turned on to show different illumination zones. The middle, left and right illumination zones are created by different orientations of the exit facets. However, the angle θ between the reflector and the horizon of respective reflectors can be changed to adjust the illumination zones.

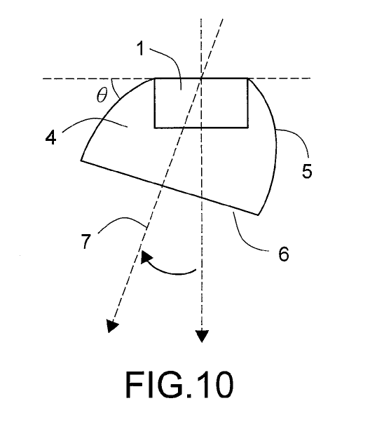

FIG. 10 schematically illustrates a lighting unit of the movable lighting system according to a second preferred embodiment of the present invention. The light source 1 and the main body 5 and the exit facet 6 of the reflector 4 of FIG. 10 are similar to those shown in FIG. 4, and are not redundantly described herein. In this embodiment, the angle θ between the external surface of the main body 5 and the horizon is asymmetrically distributed with respect to the optical axis 7. The other features are similar to those shown in FIG. 4, and are not redundantly described herein.

In the above embodiments, the light sources used in the movable lighting system of the present invention include for example incandescent bulbs, mercury vapor lamps or light emitting diodes (LEDs). Moreover, the light source can be a LED array having a plurality of LEDs arranged in a rectangular or circular form.

From the above descriptions, the movable lighting system of the present invention is capable of providing an adjustable illumination zone and an adjustable illumination-covering area by controlling the bevel angles and bevel orientations of respective exit facets. In addition, the movable lighting system of the present invention has a simplified structure.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A movable lighting system comprising at least one lighting unit, the lighting unit including a light source and a reflector, the reflector enclosing the light source and comprising a main body and an exit facet, wherein the exit facet of the reflector is beveled with respect to the horizon and adjustable to provide a desired illumination zone and a desired illumination-covering area.

2. The movable lighting system according to claim 1 wherein the light source is a LED.

3. The movable lighting system according to claim 1 wherein the lighting unit is arranged in an array having the rectangular or circular form.

4. The movable lighting system according to claim 1 wherein an inner surface of the main body of the reflector is coated with a reflective film for reflecting the scattered light emitted by the light source, so that the proportion of the scattered emergent light is reduced and the light intensity within the illumination zone is increased.

5. The movable lighting system according to claim 4 wherein the inner surface of the main body of the reflector is a partially reflective surface or a totally reflective surface.

6. The movable lighting system according to claim 4 wherein the shape of the main body includes an ellipsoid, a hyperboloid, a paraboloid, a compound ellipsoid or a compound paraboloid.

7. The movable lighting system according to claim 1 wherein the emergence angle of the light for the lighting unit is determined according to the profile of the exit facet.

8. The movable lighting system according to claim 7 wherein the exit facet is a bevel plane or includes a bevel lens surface.

9. The movable lighting system according to claim 8 wherein the bevel lens surface is a spherical lens surface, an aspherical lens surface or a Fresnel lens surface.

10. The movable lighting system according to claim 1 wherein an angle between an external surface of the main body and the horizon is symmetrically distributed with respect to the optical axis.

11. The movable lighting system according to claim 1 wherein an angle between an external surface of the main body and the horizon is asymmetrically distributed with respect to the optical axis.

12. The movable lighting system according to claim 1 wherein the illumination zone has a centralized illumination region, which is not located in the middle of the illumination zone.
